(19) United States
(12) Patent Application Publication
(10) Pub. No.: US 2012/0080953 A1
(43) Pub. Date: Apr. 5, 2012

(54) MULTI-INPUT POWER SUPPLY APPARATUS WITH REGULABLE OUTPUT POWER

(76) Inventor: Chia-Hua WANG, Taipei City (TW)

(21) Appl. No.: 12/896,943

(22) Filed: Oct. 4, 2010

(51) Int. Cl. H02J 4/00

(52) U.S. Cl. 307/72

(57) ABSTRACT

A multi-input power supply apparatus with regulable output power includes an AC-to-DC conversion unit, a DC-to-DC conversion unit, an output voltage control unit, and an output power status display unit. The AC-to-DC conversion unit has an AC-to-DC stage feedback control subunit. The DC-to-DC conversion unit has a current sensing subunit, a DC-to-DC conversion subunit, a filter subunit, a protective disconnecting switch subunit, and a DC-to-DC stage feedback control subunit. The output voltage control unit provides a signal to the AC-to-DC stage feedback control subunit and the DC-to-DC stage feedback control subunit, thus regulating the output voltage of the AC-to-DC conversion unit and the output voltage of the DC-to-DC conversion unit. The output power status display unit displays the output voltage.

### BACKGROUND OF THE INVENTION

1. Field of the Invention

The present invention relates to a multi-input power supply apparatus, and more particularly to a multi-input power supply apparatus with regulable output power.

2. Description of Prior Art

A dual-input power supply has an AC power input and a DC power input. The AC power input and the DC power input are converted into the DC output voltage.

When the dual-input power supply is used indoor and the AC power input is inserted into the AC utility power, the AC utility power is converted into the DC output voltage through an AC-to-DC conversion circuit of the dual-input power supply.

When the dual-input power supply is used outdoor and the DC power input is inserted into a car socket, and the DC power, which is outputted from the car socket, is converted into the DC output voltage through a DC-to-DC conversion circuit of the dual-input power supply.

The AC-to-DC conversion circuit of the conventional dual-input power supply has the transformer and the fuse, and the transformer and the fuse provide the overcurrent isolation and protection. However, the DC-to-DC conversion circuit does not have the overcurrent protection design. Hence, the applied electric appliance would be damaged once the overcurrent operation occurs. Furthermore, the output voltage of the conventional dual-input power supply is shown on a scale and the shown output voltage is controlled. Accordingly, the measured output voltage tends to have wrong readout and the output voltage would be undesirably changed by careless touch.

### SUMMARY OF THE INVENTION

In order to overcome the above-mentioned disadvantages, a multi-input power supply apparatus with regulable output power is disclosed.

In order to achieve the above-mentioned objectives, a multi-input power supply apparatus with regulable output power includes an AC-to-DC conversion unit, a DC-to-DC conversion unit, an output voltage control unit, and an output power status display unit. The DC-to-DC conversion unit is electrically connected to the AC-to-DC conversion unit. The output voltage control unit is electrically connected to the AC-to-DC conversion unit and the DC-to-DC conversion unit, respectively. The output power status display unit is electrically connected to the output voltage control unit.

The AC-to-DC conversion unit includes an AC-to-DC stage feedback control subunit electrically connected to the output voltage control unit. The DC-to-DC conversion unit includes a current sensing subunit, a DC-to-DC conversion subunit, a filter subunit, a DC-to-DC stage feedback control subunit, and a protective disconnecting switch subunit. The DC-to-DC conversion subunit is electrically connected to the current sensing subunit. The filter subunit is electrically connected to the DC-to-DC conversion subunit. The DC-to-DC stage feedback control subunit is electrically connected to the filter subunit, the DC-to-DC conversion subunit, and the output voltage control unit, respectively. The protective disconnecting switch subunit is electrically connected to the filter subunit, the DC-to-DC conversion subunit, the current sensing subunit, and the DC-to-DC stage feedback control subunit, respectively.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a multi-input power supply apparatus with regulable output power according to the present invention.

### DETAILED DESCRIPTION OF THE INVENTION

Reference will now be made to the drawing figures to describe the present invention in detail.

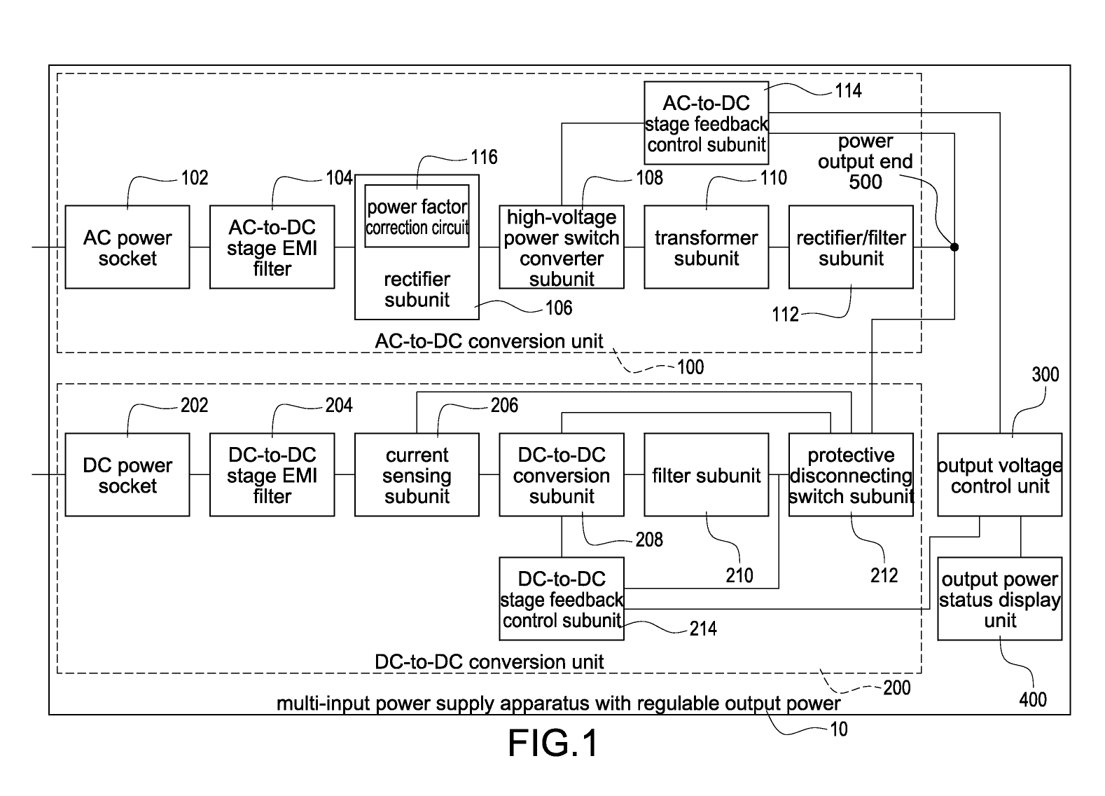

Reference is made to FIG. 1 which is a block diagram of a multi-input power supply apparatus with regulable output power according to the present invention. The multi-input power supply apparatus with regulable output power 10 includes an AC-to-DC conversion unit 100, a DC-to-DC conversion unit 200, an output voltage control unit 300, an output power status display unit 400, and a power output end 500.

The AC-to-DC conversion unit 100 has an AC power socket 102, an AC-to-DC stage EMI filter 104, a rectifier subunit 106, a high-voltage power switch converter subunit 108, a transformer subunit 110, a rectifier/filter subunit 112, and an AC-to-DC stage feedback control subunit 114. The rectifier subunit 106 has a power factor correction circuit 116.

The DC-to-DC conversion unit 200 has a DC power socket 202, a DC-to-DC stage EMI filter 204, a current sensing subunit 206, a DC-to-DC conversion subunit 208, a filter subunit 210, a protective disconnecting switch subunit 212, and a DC-to-DC stage feedback control subunit 214.

The AC-to-DC stage EMI filter 104 is electrically connected to the AC power socket 102 and the rectifier subunit 106. The high-voltage power switch converter subunit 108 is electrically connected to the rectifier subunit 106, the AC-to-DC stage feedback control subunit 114, and the transformer subunit 110. The rectifier/filter subunit 112 is electrically connected to the transformer subunit 110 and the power output end 500, respectively. The output voltage control unit 300 is electrically connected to the AC-to-DC stage feedback control subunit 114, the output power status display unit 400, and the DC-to-DC stage feedback control subunit 214, respectively. The AC-to-DC stage feedback control subunit 114 is electrically connected to the power output end 500.

The DC-to-DC stage EMI filter 204 is electrically connected to the DC power socket 202 and the current sensing subunit 206, respectively. The DC-to-DC conversion subunit 208 is electrically connected to the current sensing subunit 206, the DC-to-DC stage feedback control subunit 214, the filter subunit 210, and the protective disconnecting switch subunit 212, respectively. The protective disconnecting switch subunit 212 is electrically connected to the filter subunit 210, the current sensing subunit 206, the DC-to-DC stage feedback control subunit 214, and the power output end 500. The DC-to-DC stage feedback control subunit 214 is electrically connected to the filter subunit 210.

The high-voltage power switch converter subunit 108 can be a flyback converter, a forward converter, a half-bridge converter, an active clamp flyback converter, or an active clamp forward converter. The DC-to-DC conversion subunit 208 can be a buck converter, a boost converter, a buck-boost converter, or a single-ended primary-inductor converter (SPEIC converter).

The protective disconnecting switch subunit 212 is opened (turned off) to isolate the AC-to-DC conversion unit 100 and the DC-to-DC conversion unit 200 when an input current, which is sensed by the current sensing subunit 206, is larger than a current default value or the DC-to-DC conversion subunit 208 is not operated or the input voltage at DC power socket 202 is too high.

The output voltage control unit 300 provides a signal to the AC-to-DC stage feedback control subunit 114 and the DC-to-DC stage feedback control subunit 214, thus regulating the output voltage (outputted at the power output end 500) of the AC-to-DC conversion unit 100 and the output voltage (outputted at the power output end 500) of the DC-to-DC conversion unit 200. The output voltage control unit 300 includes a double-pole switch (not shown), a single-pole switch (not shown), or a pushbutton switch.

The output power display status unit 400 displays the output voltage of the multi-input power supply apparatus with regulable output power 10. That is, the manner of displaying and regulating the output voltage of the present invention is different from that of the prior art. The output voltage can be read only if the user watches the output power status display unit 400. Also, the measured output voltage has correct readout and would not be wrong value due to careless touch. The output power status display unit 400 can further assemble a lighting apparatus for user to easily watch the output voltage. Furthermore, the output power status display unit 400 can use different symbols, geometrical graphs, or colors to distinguish the different output voltages.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-input power supply apparatus with regulable output power, comprising:
an AC-to-DC conversion unit;
a DC-to-DC conversion unit electrically connected to the AC-to-DC conversion unit;
an output voltage control unit electrically connected to the AC-to-DC conversion unit and the DC-to-DC conversion unit, respectively; and
an output power status display unit electrically connected to the output voltage control unit;
wherein the AC-to-DC conversion unit has an AC-to-DC stage feedback control subunit, the AC-to-DC stage feedback control subunit electrically connected to the output voltage control unit;
and the DC-to-DC conversion unit has:
a current sensing subunit;
a DC-to-DC conversion subunit electrically connected to the current sensing subunit;
a filter subunit electrically connected to the DC-to-DC conversion subunit;
a DC-to-DC stage feedback control subunit electrically connected to the filter subunit, the DC-to-DC conversion subunit, and the output voltage control unit, respectively; and
a protective disconnecting switch subunit electrically connected to the filter subunit, the DC-to-DC conversion subunit, the current sensing subunit, and the DC-to-DC stage feedback control subunit, respectively.

2. The multi-input power supply apparatus in claim 1, wherein the AC-to-DC conversion unit further comprises:
a rectifier/filter subunit electrically connected to the AC-to-DC stage feedback control subunit; and
a transformer subunit electrically connected to the rectifier/filter subunit.

3. The multi-input power supply apparatus in claim 2, wherein the AC-to-DC conversion unit further comprises a high-voltage power switch converter subunit electrically connected to the transformer subunit and the AC-to-DC stage feedback control subunit, respectively.

4. The multi-input power supply apparatus in claim 3, wherein the AC-to-DC conversion unit further comprises:
a rectifier subunit electrically connected to the; and
an AC-to-DC stage EMI filter electrically connected to the rectifier claim 4, wherein the rectifier subunit has a power factor correction circuit.

5. The multi-input power supply apparatus in claim 4, wherein the rectifier subunit has a power factor correction circuit.

6. The multi-input power supply apparatus in claim 5, wherein the AC-to-DC conversion unit further comprises an AC power socket electrically connected to the AC-to-DC stage EMI filter.

7. The multi-input power supply apparatus in claim 6, wherein the high-voltage power switch converter subunit is a flyback converter, a forward converter, a half-bridge converter, an active clamp flyback converter, or an active clamp forward converter.

8. The multi-input power supply apparatus in claim 7, wherein the DC-to-DC conversion unit further comprises a DC-to-DC stage EMI filter electrically connected to the current sensing subunit.

9. The multi-input power supply apparatus in claim 8, wherein the DC-to-DC conversion unit further comprises a DC power socket electrically connected to the DC-to-DC stage EMI filter.

10. The multi-input power supply apparatus in claim 9, wherein the DC-to-DC conversion subunit is a buck converter, a boost converter, a buck-boost converter, or a single-ended primary-inductor converter (SPEIC converter).
